(19) United States
(12) Patent Application Publication
(10) Pub. No.: US 2003/0133653 A1
(43) Pub. Date: Jul. 17, 2003

(54) Optical filter and a filter method

(75) Inventors: Carlos De Barros, Boulogne-Billancourt (FR); Hedi Labidi, Paris (FR); Xavier Bonnet, St Remy Les Chevreuse (FR); Isabelle Riant, Orsay (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/330,145

(22) Filed: Dec. 30, 2002

(30) Foreign Application Priority Data
Jan. 3, 2002 (FR) 02 00 040

(51) Int. Cl. G02B 6/26

(52) U.S. Cl. 385/27

(57) ABSTRACT

An optical filter includes a coupler having n output branches and an input branch receiving an input signal whose spectrum comprises a comb of wavelengths periodically spaced by a spacing eP. Each of the n output branches is coupled to a waveguide including two or more cascaded copropagated coupling components. Each of the n branches produces an output signal whose spectrum comprises a comb of wavelengths periodically spaced by a spacing equal to n times the spacing eP. Each of the n output signal spectra is complementary to the others.

### CROSS-REFERENCE TO RELATED APPLICATIONS

This application is based on French Patent Application No. 02 00 040 filed Jan. 3, 2002, the disclosure of which is hereby incorporated by reference thereto in its entirety, and the priority of which is hereby claimed under 35 U.S.C. §119.

### BACKGROUND OF THE INVENTION

1. Field of the Invention

The invention relates to an optical filter receiving an input signal whose spectrum comprises a comb of periodically spaced wavelengths.

The invention also relates to a filter method.

2. Description of the Prior Art

The field of the invention is that of optical telecommunications and more particularly that of optical filtering.

Some existing filters separate an input signal whose spectrum comprises a comb P of N wavelengths each carrying a signal into two output signals whose spectra comprise two complementary combs P1, P2 of N/2 wavelengths such that the wavelength spacing e, which is exactly the same for the two combs P1 and P2, is twice the spacing eP of the comb P.

Filters of the above kind are referred to hereinafter as interleavers. They are used to route optical telecommunications, for example.

At present there are various technologies for implementing an interleaver.

A first of these technologies employs a demultiplexer using an array of waveguides connecting two star couplers; this kind of demultiplexer is often called a phasar (phase arrayed-waveguide grating (AWG) demultiplexer).

In this technology, signals carried by a comb P of N wavelengths λ₁, . . . , λ_{N} fed to the input of the AWG phasar are separated into N signals each carried by a wavelength λ₁. The separated signals are then grouped or interleaved using two phasars with slightly offset periods to constitute the two combs P1 and P2.

However, this technology introduces high losses, exceeding 5 dB.

Another technology employs a Mach-Zehnder interferometer. As shown in FIG. 1a, the comb P of N wavelengths is split by a first coupler C1 between two optical fibers F1 and F2, introducing a respective delay R1, R2 into subcombs p1, p2 of N wavelengths each at half the original intensity; the two fibers F1 and F2 are coupled by a coupler C2 to obtain interference between the combs p1 and p2 so as to split the original comb P into two combs P1 and P2; the period of the two combs P1 and P2 is then a function of the period of the interference.

This technology necessitates two couplers in series, although it is necessary to reduce the bulk and the number of components used in an interleaver for cost reasons; implementing the above kind of component is difficult in terms of reproducibility.

Another technology employs a circulator Cr and N cascaded Bragg gratings RB₁, . . . , RB_{N}, each grating RB₁ filtering a wavelength λ₁ by reflection. A Bragg grating is obtained by writing into the core of the optical fiber a grating whose period determines the filtered wavelength. Writing N Bragg gratings each having a different period reliably and reproducibly is difficult.

The Bragg gratings can instead be sampled gratings. As shown in FIG. 1b, a sampled grating comprises the same Bragg grating RB written into the core of the fiber F through a window M: the Bragg grating is modulated by the window.

The response R of the sampled grating, shown in FIG. 1c, is a reflector comb in which the wavelength spacing e is a function of the period of the window M. The power of the signals carried by each wavelength of the comb obtained in response varies as a function of the wavelength. The solution that involves widening the envelope E to have the same power for each wavelength has the drawback of increasing losses over the whole of the filter band. To obtain a very wide envelope, the width of each photowritten area of the window M must be as small as possible; it is therefore difficult to achieve maximum reflectivity over small areas without introducing losses.

The object of the present invention is therefore to provide an interleaver that is not subject to the drawbacks previously mentioned.

### SUMMARY OF THE INVENTION

The invention provides an optical filter including a coupler having a plurality of output branches and an input branch receiving an input signal whose spectrum comprises a comb P of periodically spaced wavelengths, in which filter each output branch is coupled to a waveguide including two or more cascaded copropagated coupling components, each branch produces an output signal whose spectrum comprises a comb (P1 or P2) of periodically spaced wavelengths having a spacing equal to the spacing of said input signal comb multiplied by the number of output branches, and each output signal spectrum is complementary to the others.

The waveguide can be an optical filter or a planar waveguide.

The copropagating coupling components are advantageously long-period gratings.

The waveguide can be a monomode waveguide or a multimode waveguide.

The copropagating coupling components of one of said waveguides preferably have identical lengths.

According to a further feature of the invention, the waveguides have a core index n_{c} and a cladding index n_{g} over the portion of the guide including the copropagating coupling components and the indices n_{c} and n_{g} of one waveguide are identical to those of the other waveguides.

The invention also provides a method of filtering a signal whose spectrum comprises a comb of periodically spaced wavelengths, which method includes the following steps:

a) using an optical filter as claimed in claim 1 to produce output signals, and

b) offsetting the spectra of the output signals relative to each other by adjusting and/or tuning one or more of the copropagating coupling components of each waveguide of the optical filter.

The adjustment and/or the tuning of step b) can be achieved by mechanically and/or thermally stressing the copropagating coupling component.

According to one feature of the invention, each of the waveguides introduces an optical path difference between the portion of the signal coupled by the copropagating coupling components and the remaining portion of the signal and the method further includes a step of modifying the optical path difference for one or more of the waveguides.

The copropagating coupling components of the waveguide being separated by a distance L, the modification can be achieved by varying the distance L.

The waveguide having a core index n_{c} and a cladding index n_{g} over the portion or portions separating the copropagating coupling components, and the indices corresponding to the effective indices n_{effc} of a core mode and n_{effg} of a cladding mode, respectively, the modification can also obtained by varying the effective index n_{effc} and/or n_{effg}.

According to one feature of the invention, the modification is obtained by exposing the portion of the waveguide between the copropagating coupling components to UV radiation and/or by thermally stressing the portion of the waveguide between the copropagating coupling components.

Other features and advantages of the invention will become clearly apparent on reading the following description given by way of nonlimiting example and with reference to the accompanying drawings.

### BRIEF DESCRIPTION OF THE DRAWINGS

FIGS. 1a, 1b and 1c, already described, respectively show in diagrammatic form a Mach-Zehnder interferometer, a sampled Bragg grating, and the response of the sampled Bragg grating, all of which are used to produce a prior art interleaver.

FIG. 2 shows diagrammatically an optical filter according to the invention.

FIG. 3 shows diagrammatically an optical fiber F1 including two long-period gratings LPG1, LPG2.

FIG. 4 shows diagrammatically an example of combs P1 and P2 obtained using a filter according to the invention.

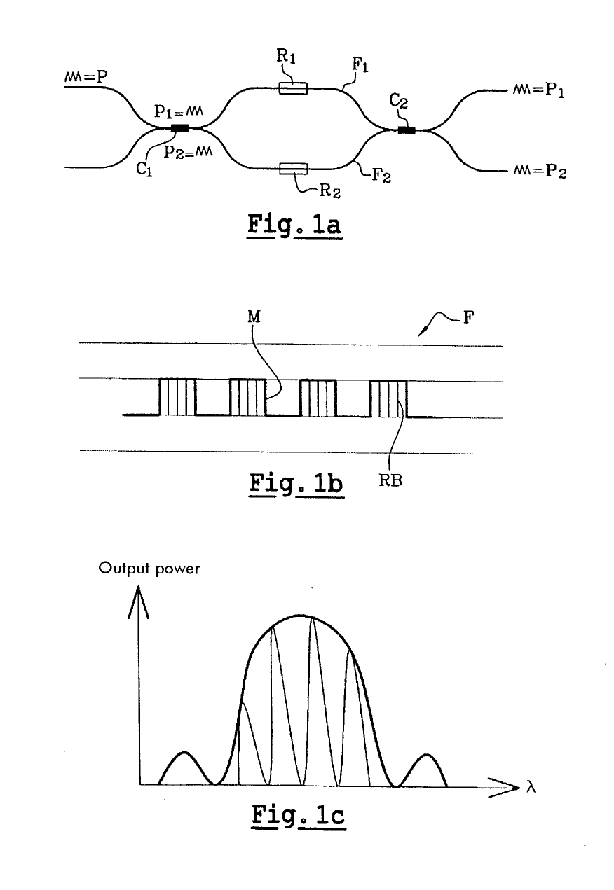

### DETAILED DESCRIPTION OF THE PREFERRED EMBODIMENT

The optical filter according to the invention aims to obtain from a comb P of N wavelengths m (m >1) combs in which the wavelength spacing e is a multiple of the spacing eP of the original comb P:

e=m×eP

Each comb can have the same intensity, given that their sum is less than or equal to that of the original comb P; the intensity can instead vary from one comb to another.

The remainder of the description refers more particularly to an optical filter for obtaining two combs P1, P2 (m=2) in which the wavelength spacing is therefore twice that of the original comb P.

With regard to the intensity of each comb P1, P2, if the signals carried by the comb P2 must travel a greater distance than those carried by the comb P1, for example, they can be split unequally, for example 30% to P1 and 70% to P2. For simplicity, the remainder of the description assumes that the intensity of each comb P1 and P2 is 50% of that of the original comb P.

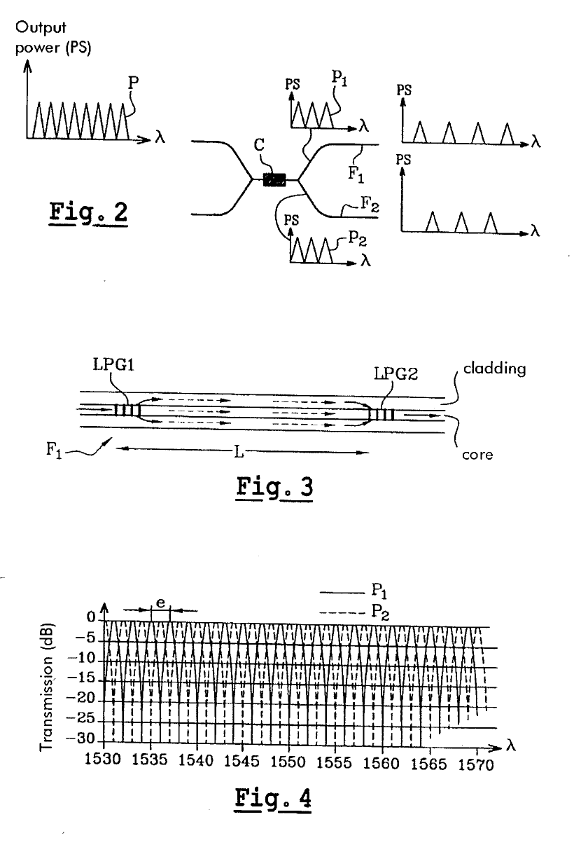

As shown in FIG. 2, the optical filter according to the invention includes a coupler C for splitting the comb P between two branches each coupled to a waveguide F1, F2, producing two subcombs p1, p2 also of N wavelengths but at half the original intensity.

The waveguide can be a monomode guide or a multimode guide, but is preferably a monomode guide.

The waveguide chosen can be an optical fiber or a planar waveguide, for example. The remainder of the description refers to optical fibers F1 and F2.

As shown for the fiber F1 in FIG. 3, which corresponds to a preferred embodiment of the invention, each optical fiber has two or more long-period gratings LPG1, LPG2 in cascade, written into the core and/or into the cladding of the optical fiber F1 and separated by a distance L between the beginning of the grating LPG1 and the beginning of the grating LPG2.

A long-period grating is a special case of a Bragg grating written into the core of the optical fiber. However, while the period of a Bragg grating is generally of the order of 0.5 μm, that of a long period grating can be from a few μm to a few hundred μm.

As a result of this, instead of being reflected toward the rear, as in a Bragg grating, which is therefore described as contrapropagating, the signal carried by the wavelength partly filtered by the long-period grating is partly coupled into a forward cladding mode; the long-period grating is then described as copropagating. The index of the covering of the cladding is determined so that the cladding mode is guided in the cladding, which has an index n_{g}, and not absorbed by the covering.

The portion of the signal that is not coupled by the grating LPG1 into the cladding mode propagates along the core of the optical fiber, which has an index n_{c}.

The respective optical paths along the core and along the cladding thus form the two arms of a Mach-Zehnder interferometer. The signal carried by the cladding mode is then coupled by the second long-period grating LPG2 into the core of the fiber, where it interferes with the signal transmitted along the core of the optical fiber. This applies to each of the wavelengths concerned.

The two gratings LPG1 and LPG2, with respective lengths d1 and d2, are preferably the same length (d1=d2=d). If the distance L is greater than the length d, the interference obtained at the output of the grating LPG2 (i.e. the comb) has a spacing e determined by the equation, in which λ is the filtered wavelength:

e=λ²/(Δm×L

$$Δ m = ( {n}_{effc} - {n}_{effg} ) - λ \times \frac{ⅆ}{ⅆ λ} ( {n}_{effc} - {n}_{effg} )$$

where n_{effc} is the effective index of the fundamental mode propagating in the core of the fiber in the case of a monomode fiber and n_{effg} is the effective index of the cladding mode propagating in the cladding G. In the case of a multimode fiber, it is necessary to consider the effective indices n_{effc1} and n_{effc2} of the two guided modes concerned propagating in the core of the fiber.

The effective indices are those corresponding to the portion of fiber including the two long period gratings, of course.

In the field of optical telecommunications, for example when transmitting on 32 wavelengths in the C band, from approximately 1530 nm to approximately 1560 nm, the spacing eP is equal to 0.8 nm. The present tendency is to use 64 wavelengths in the same band, in which case the spacing is equal to 0.4 nm.

For a more detailed description of the spacing between the interference fringes, see “Dependence of fringe spacing on the grating separation in a long-period fiber grating pair” by B. Ha Lee and J. Nishii, Applied Optics, Vol.38, No.16, Jun. 1, 1999.

A transmission curve for the interference obtained is represented by a continuous line in FIG. 4: this example of a comb P1 was obtained with the following parameters:

Fiber index difference: 4×10⁻³

Cladding mode: LP03

Length d of gratings LPG1 and LPG2: 10 mm

Period of long-period grating: 190 μm

Distance D: 50 cm

This transmission curve shows that all wavelengths that are transmitted are transmitted with the same power but those which are not transmitted are attenuated or isolated by an amount depending on the wavelength. The curve has an envelope (truncated in FIG. 4) which must be relatively wide and relatively contrasted for the wavelengths that are not transmitted to be attenuated (isolated) by an amount above a particular threshold. For example, in the field of optical telecommunications, the threshold must be greater than approximately 25 dB.

Similarly, the fiber F2 includes two long-period gratings LPG1 and LPG2, which are preferably identical, as was the case for the fiber F1. The gratings LPG1 and LPG2 of the fiber F2 are designed to produce the same system of fringes as the gratings LPG1 and LPG2 of the fiber F1, but offset to obtain a comb P2 complementary to the comb P1. The N wavelengths of the comb P2 are slightly offset relative to those of the comb P1; the offset is of the order of eP.

The fiber F2 has a core index n_{c} and a cladding index n_{g} which are preferably identical to those of the fiber F1 and includes two gratings LPG1 and LPG2 that are preferably separated by the same distance L as and identical to those of the fiber F1. The spectral offset is obtained by adjusting and/or tuning the gratings LPG1 and/or LPG2 of the fiber F2 and/or F1.

The adjustment is performed once and for all, for example to conform to the specifications when the filter is installed in the optical system for which it is intended.

Tuning is effected dynamically during operation of the filter, for example to correct a frequency drift caused by aging of the filter or if the number of transmission wavelengths of the optical system is modified.

The spectral offset can be obtained by mechanically and/or thermally stressing the grating LPG1 and/or LPG2 of the fiber F2 and/or F1, for example.

A comb P2 is represented in FIG. 4 by a dashed line. It was obtained from a fiber F2 incorporating gratings LPG1 and LPG2 identical to those of the fiber F1 and separated by the same distance L. The spectral offset was obtained by heating the grating LPG1 of the fiber F2.

In the embodiment described with reference to FIGS. 3 and 4, each of the fibers includes two long-period gratings LPG1 and LPG2. However, the invention is not limited to an optical filter including long-period gratings; it applies more generally to any optical filter including two or more copropagating coupling components, able to couple into the same mode a portion of the received signal, referred to herein for simplicity as copropagating coupling components.

The optical filter according to the invention has the advantage of providing filtering with low losses (only those caused by the coupler); furthermore, these losses are not dependent on the wavelength.

The above kind of filter is easy and inexpensive to produce and is therefore highly suitable for mass production.

The optical path difference between the portion of the signal coupled by the copropagating coupling components and the remaining portion of the signal can be modified to modify the spacing of the fringes of the optical filter according to the invention on one or more branches of the filter, or even on all the branches.

Like the spectral offset, this spacing can be obtained by adjustment and/or by tuning.

To reduce the spacing e, it is sufficient to increase the distance L between the two gratings.

Another solution is to increase (or reduce) Am by varying the effective indices of the core mode and/or the cladding mode over the fiber portion between the gratings LPG1 and LPG2. These variations can be caused thermally or by applying mechanical stresses.

These two solutions can be implemented once and for all or dynamically.

The spacing of the fringes can also be modified by changing the optical path difference by exposing the portion of the fiber between the two gratings in a specific manner to uniform UV radiation, for example.

There is claimed:

1. An optical filter including a coupler having a plurality of output branches and an input branch receiving an input signal whose spectrum comprises a comb of periodically spaced wavelengths, in which filter each output branch is coupled to a waveguide including two or more cascaded copropagated coupling components, each branch produces an output signal whose spectrum comprises a comb of periodically spaced wavelengths having a spacing equal to the spacing of said input signal comb multiplied by the number of output branches, and each output signal spectrum is complementary to the others.

2. The optical filter claimed in claim 1 wherein said waveguide is an optical filter or a planar waveguide.

3. The optical filter claimed in claim 1 wherein said copropagating coupling components are long-period gratings.

4. The optical filter claimed in claim 1 wherein said waveguide is a monomode waveguide.

5. The optical filter claimed in claim 1 wherein said waveguide is a multimode waveguide.

6. The optical filter claimed in claim 1 wherein said copropagating coupling components have identical lengths.

7. The optical filter claimed in claim 1 wherein said waveguides have a core index n_{c} and a cladding index n_{g} over the portion of said guide including said copropagating coupling components and said indices n_{c} and n_{g} of one waveguide are identical to those of the other waveguides.

8. A method of filtering a signal whose spectrum comprises a comb of periodically spaced wavelengths, which method includes the following steps:
a) using an optical filter as claimed in claim 1 to produce output signals, and
b) offsetting the spectra of said output signals relative to each other by adjusting and/or tuning one or more of said copropagating coupling components of each waveguide of said optical filter.

9. The method claimed in claim 8 wherein said adjustment and/or said tuning of step b) is achieved by mechanically and/or thermally stressing said copropagating coupling component.

10. The method claimed in claim 8 wherein each of said waveguides introduces an optical path difference between the portion of said signal coupled by said copropagating coupling components and the remaining portion of said signal and said method further includes a step of modifying said optical path difference for one or more of said waveguides.

11. The method claimed in claim 10 wherein said copropagating coupling components of said waveguide are separated by a distance L and said modification is achieved by varying said distance L.

12. The method claimed in claim 10 wherein said waveguide has a core index n_{c} and a cladding index n_{g} over the portion or portions separating said copropagating coupling components, said indices correspond to the effective indices n_{effc} of a core mode and n_{effg} of a cladding mode, respectively, and said modification is obtained by varying said effective index n_{effc} and/or n_{effg}.

13. The method claimed in claim 1 0 wherein said modification is obtained by exposing the portion of said waveguide between said copropagating coupling components to UV radiation.

14. The method claimed in claim 1 0 wherein said modification is obtained by thermally stressing the portion of said waveguide between said copropagating coupling components.
